(19) United States
(12) Patent Application Publication
(10) Pub. No.: US 2016/0140576 A1
(43) Pub. Date: May 19, 2016

(54) DETERMINING PUBLISHING DATE FOR MARKET REPORTING

(71) Applicant: SAP SE, Walldorf (DE)

(72) Inventors: Gebhard Roos, Hamburg (DE); Manfred Hahne, Hirschberg (DE); Katharina Seiz, Muehlhausen (DE); Stefanie Brunner, Bruehl (DE); Bernhard Bittermann, Heidelberg (DE); Thomas Collet, Walldorf (DE); Markus Stege, Limburgerhof (DE); Alexander Grendel, Bad Schoenborn (DE)

(21) Appl. No.: 14/543,358

(22) Filed: Nov. 17, 2014

(51) Int. Cl. G06Q 30/02; G06Q 10/06

(52) U.S. Cl. CPC G06Q 30/0201; G06Q 10/067

(57) ABSTRACT

Methods and systems define a publishing group and/or select a publishing date. The method may customize and optimize a planned publishing date. Data may be received from a plurality of different data sources on different time schedules. Data may be extrapolated and the data sets harmonized in time, which may partially form the basis for selecting a publishing date. The method may automatically determine a publishing date based on an amount of data that would be extrapolated for various potential publishing dates. Analysis regarding a publishing date, including the amount of data for each database covered in a reporting period, may be rendered on a user interface. The system may include a global report processor including a processor for grouping regions and/or categories and suggesting/selecting a publishing date.

### BACKGROUND

Modern businesses often purchase relevant data from various market research companies. Market data may be used by the businesses to make decisions. For example, market data may indicate how well products are selling well in a target market, or whether market shares are growing, etc., which can be useful for a business reviewing its strategic plans. The market data can be provided via databases. For example, a local or regional department of a company may use the data for local market share analysis for the region and/or countries for which the local department is responsible. In this situation, the local department may extract data from a single database and generate a report based on that database. On the other hand, a global marketing development may consolidate different databases to build a global picture for global market share analysis.

That is, a user may receive market data from several different databases of different market research companies for different categories of market data, and for different countries or regions. As market research companies typically compile and deliver the market data at different time intervals, not all of the desired data may be delivered and/or available at the time when a company wishes to review the data. The end-user company may need to understand the costs and benefits of different publication dates for a specific group of data sources. The choice and use of particular publication dates and times may cause the display of data to be more or less helpful for a user. For example, if global market share values are updated every time a new database becomes available, global marketers may become confused. Data consolidation poses particular challenges, due in part to varying data delivery periods.

### BRIEF DESCRIPTION OF THE DRAWINGS

FIG. 1 illustrates a demand signal management system according to an embodiment.

FIG. 2 illustrates a data delivery scheme according to an embodiment.

FIG. 3 illustrates a method of selecting a publishing date according to an embodiment.

FIG. 4A illustrates a scheme for defining publishing groups according to an embodiment.

FIG. 4B illustrates a graphical user interface for defining publishing groups according to an embodiment.

FIG. 5 illustrates a delivery schedule including a reporting period according to an embodiment.

FIG. 6 illustrates a graphical user interface for displaying publishing dates and attributes according to an embodiment.

FIG. 7 illustrates a simplified block diagram of a system implementing the methods described herein according to an embodiment.

### DETAILED DESCRIPTION

Databases typically have different delivery cycles and time granularities such that data from different databases may not always be available at the same time. However, some data reporting applications rely on a variety of sources and databases to assemble a report, e.g., for a user. Thus, a situation may arise in which data records (“records” for simplicity”) are available (or delivered) at a particular point in time from a few of the databases, but not available (or delivered) from other databases.

Reporting software such as SAP® Demand Signal Management enables a user to execute a periodic report by offering an extrapolation function. The extrapolation function may temporarily replace missing records or records of poor quality until a next delivery or a corrected delivery is available. For example, an incomplete data set may temporarily be remedied by extrapolating the missing data values using most recent available data for a specific category and a specific country/region. However, if a high proportion of data is extrapolated, then the reports based on the data may be inaccurate. On the other hand, it may be inefficient to wait for complete data, i.e., to avoid extrapolation because timeliness of reporting is important for making business decisions.

The period selected for reporting, e.g., a data display refresh rate, may affect the usefulness of a report. If the refresh rate is too high, e.g., faster than the rate of analysis, then the information can overwhelm the system and cause inaccurate calculations. Therefore the data may be made public from time to time, e.g., when global data is sufficiently complete for the last calendar month. Thus, the inventors recognized a need for a system to select a publication date that strikes a balance between timely reporting and accuracy. An example of a selected publishing date may be one that does not include too many extrapolated values, where “too many” can be a defined threshold value. In other words, the inventors recognized a need for a system that can easily allow the user to customize and optimize the publication schedule of data from various data sources.

The present methods and systems may make decisions or assist decision-making regarding ways to customize and optimize a publishing date. For example, the system may automatically calculate the number of days that would be extrapolated for various publishing dates. The automatic calculation may be based on planned data delivery dates. An overview of the amount of data for each database covered in a reporting period, for each possible publishing date, may be rendered on a graphical user interface (“GUI”). The methods and systems may calculate how much data would be extrapolated and may visualize these values in the form of graphs and/or charts. One metric that may be displayed is how many days' worth of data needs to be extrapolated. The publishing date may also be referred to as a “reporting date.” For example, in some embodiments, the publishing/reporting date may serve as a basis for determining a publishing date. That is, a report need not be published on the “publishing date,” and the publishing date serves as a reference for an actual publishing time.

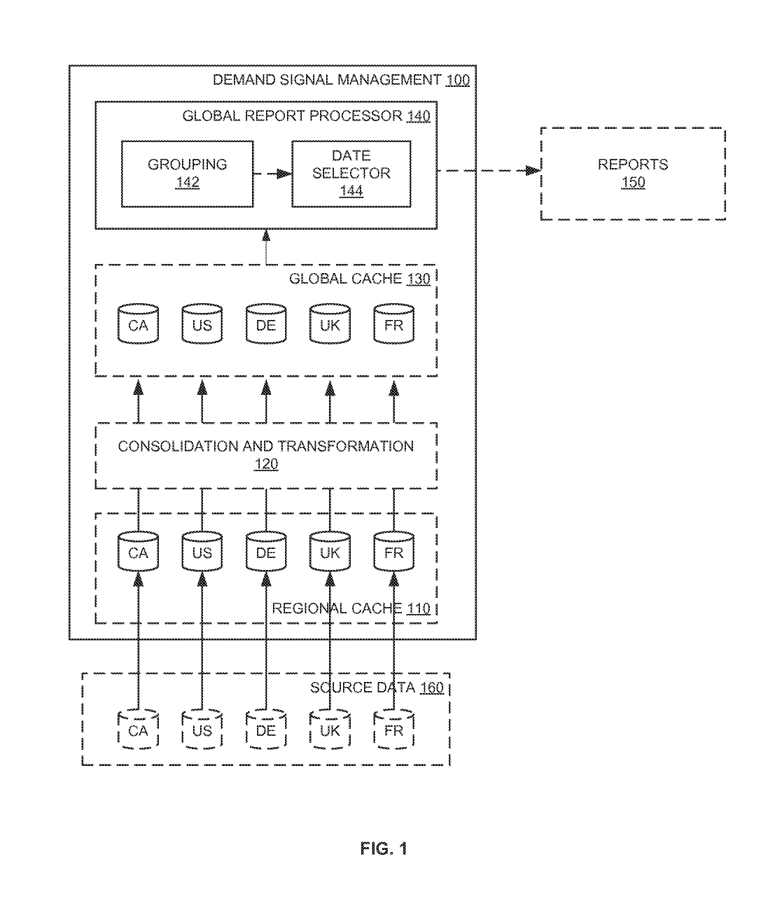

FIG. 1 illustrates an exemplary demand signal management system 100 according to an embodiment. According to an embodiment, the demand signal management system (“DSiM”) 100 may include a regional interface/cache 110, a consolidation and transformation module 120, and a global cache 130, and a global report processing module 140. In operation, the DSiM may receive data 160 from various sources, process the source data, then output data, for example for generating reports 150.

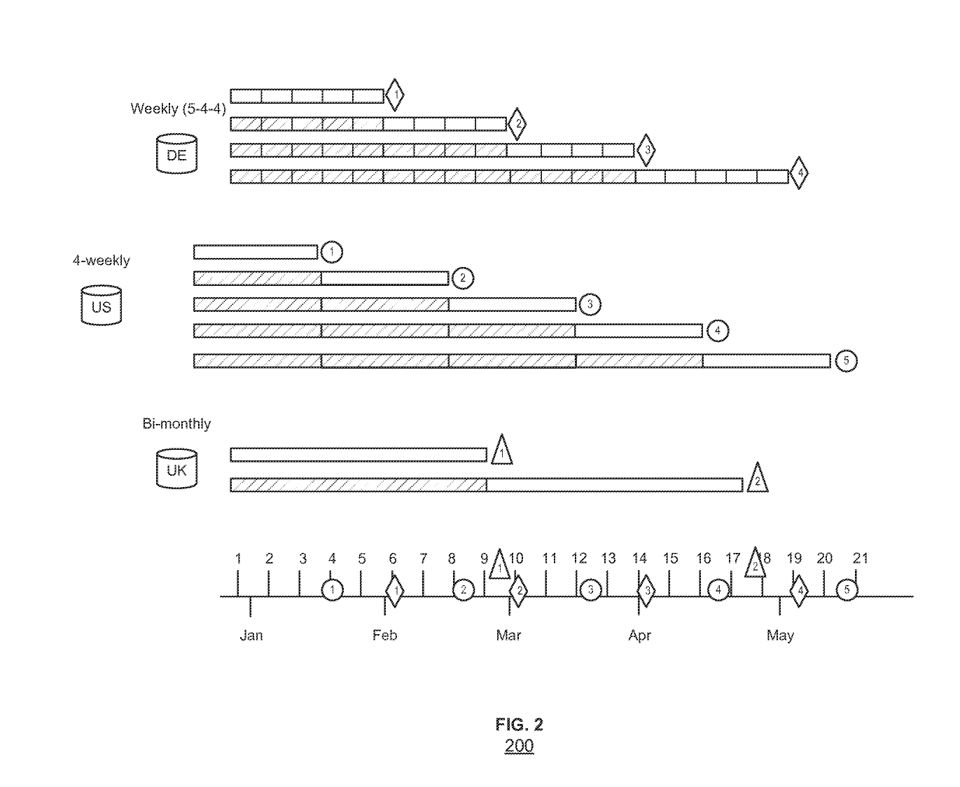

The source data 160 may be received from one or more sources such as companies providing market research data, for example Nielsen®, IRI®, and/or GFK®. The various data sources may operate on different delivery schedules, for example providing reports at different frequencies. An example delivery schedule is shown in FIG. 2 and further discussed herein.

The regional interface/cache 110 (“regional cache” for simplicity) may receive data from one or more sources 160. The local cache may be a memory storage where data, e.g., raw data, from sources regarding different regions or product categories may be received and stored. Such raw data may be in various formats, and/or may each be corresponding to different global categories and/or different countries/regions. In the example shown in FIG. 1, data is provided for regions CA (Canada), US (United States), DE (Germany), UK (Great Britain), FR (France). Other configurations and regions are also possible. The cache is represented as a “regional cache” because the data may be of special interest to regional or “local” offices. However, “regional cache” may also be understood to include caching of data for sub-regions within a larger region. In an alternative embodiment, “regional cache” may be an interface for receiving data and may pass data onto the processor without caching.

The consolidation and transformation module 120 may receive data from the regional cache 110 and process the data. Consolidation and transformation may include aggregating and/or extracting relevant data and harmonizing different delivery schedules of the source data. The consolidation and transformation may also include extrapolation and time split, as further discussed herein. The consolidation and transformation may allow the data to be better reported together. For example, the transformer may remove irrelevant data from each of the source data CA, US, DE, UK, and FR, and may perform time harmonization such as “time split,” as further discussed herein. For example, regional offices may be interested in more specific details provided by the source data 160, while a global office may be interested in a more general and high-level view of the data from the various regions. Consolidation and transformation 120 may extract data more relevant for examination by a global office.

The global cache 130 may receive data processed by the consolidation and transformation module 120. The global cache may be a memory storage where data, e.g., processed data from sources regarding different regions or product categories may be received and stored. Such data may be in various formats, and/or may each be corresponding to different global categories and/or different countries/regions. In the example shown in FIG. 1, data is provided for regions CA (Canada), US (United States), DE (Germany), UK (Great Britain), FR (France). In contrast to the regional cache of 110, the global cache 130 may include data that is more relevant for global reporting, for example, having irrelevant data removed by the consolidation and transformation module 120. Other configurations and regions are also possible. The cache is represented as a “global cache” because the data may be of special interest to global or “central” offices. However, “global cache” may also be understood to include caching of data for regions encompassing sub-regions.

The global report processor 140 may process data according to the methods described herein. For example, the global report processor may define a publishing group and select a publishing date, which are respectively represented as a grouping module 142 and a date selector 144. The data processed by the global report processor 140 may be used to generate reports 150. The processor 140 is represented as a “global report processor” because the data generated may be of interest to global or “central” offices. However, “global report processor” may also be understood to include processing of data for regions encompassing sub-regions and processing of data for purposes other than reporting.

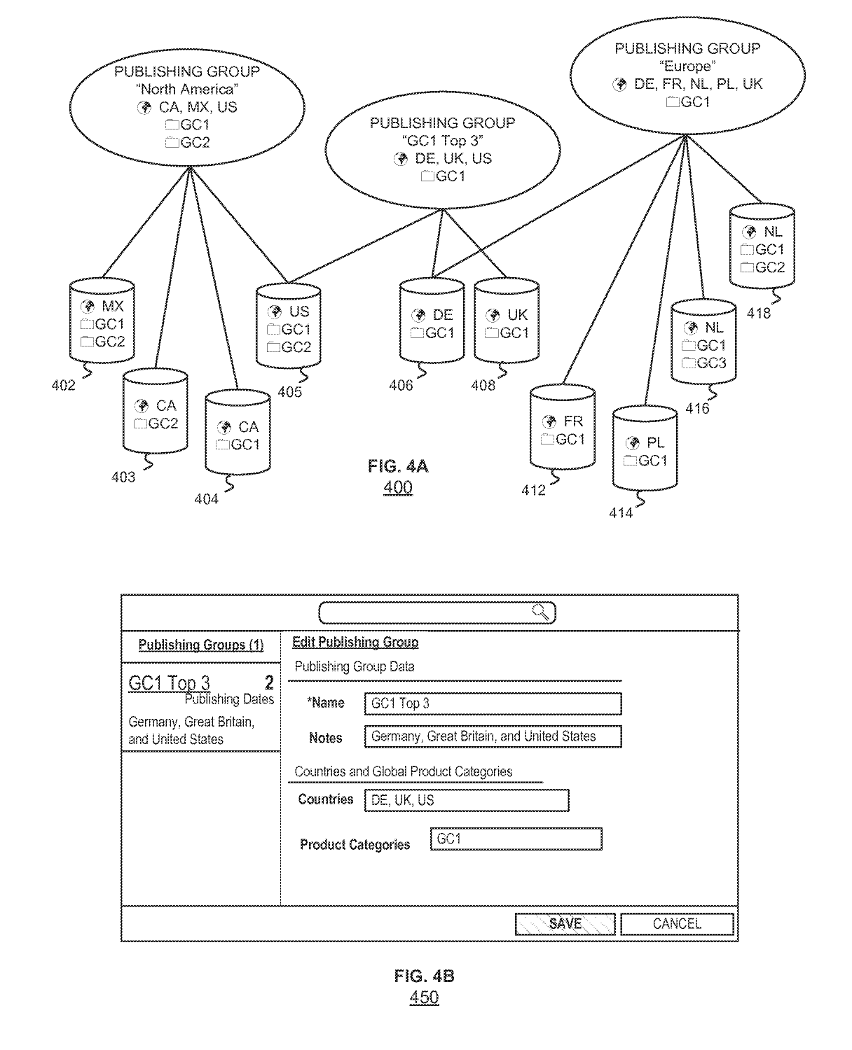

The grouping module 142 may select or describe data sets that can be grouped for global reporting. For example, data may be grouped by countries and/or categories. The categories and/or countries may be a “view” or a “filter” of a dataset. Various publishing groups for desired subsets of data may be defined by a user or may be defined automatically, for example as shown in FIGS. 4A and 4B and further discussed herein. For example, an end-user company may define publishing group PG3 as for countries US, UK and DE, and for global category GC1. Although not shown, each data source may be labeled to designate its global category, if applicable. Global categories may represent market sectors, product sectors, service sectors, etc. For example, categories may include: food, non-food grocery items, health and beauty aids, general merchandise, etc. A publishing group may be of interest for a report. For example, one may be interested in the sales of chocolate (e.g., “GC1”) in the three largest markets of DE, UK, and US. The grouping module 142 may accordingly define a group as “DE, UK, and US with chocolate (GC1).”

The date selector 144 may analyze possible publishing dates and including factors provided by the consolidation and transformation module 120 and/or user input. The date selector 144 may automatically select a publishing date based on a weighing of various factors further discussed herein. The selection of a publishing date may be based on a grouping of categories and/or countries, as represented by the dashed arrow. For example, a grouping may indicate that the delivery schedules of the databases reflecting the countries and/or categories within the grouping are more heavily weighted for selecting the publishing date.

The processor may also include a controller (not shown) that may render a GUI, respond to controls from a user of the DSiM system, send commands to the elements of the DSiM system, and output data. For example, the controller may query and/or receive user-defined settings for the system 100. The controller may customize and optimize the publishing of data based on internal calculations and/or user-indicated settings. The controller may send commands to a display device to display a GUI, and may allow the user to receive the information from the system 100 and to receive user inputs. The controller may render a list of possible publishing times to select from and/or the amount of data extrapolation required for each publishing time.

In operation, the regional cache 110 may receive and/or store raw data from external source(s) 160. A user or system administrator may define for each raw input database 160, planned data delivery dates. The dates may be agreed upon with a data provider. The agreement may also define time ranges corresponding to each delivery date. Alternatively, the system 100 may receive this information from the data provider automatically, which may be periodically updated. For example, the system 100 may receive regular forecasts from the data providers as to when the data deliveries are scheduled. This information may be a basis for generating possible publishing dates for the user for each publishing group. The consolidation and transformation module 120 may process the raw data, such as reformatting, filtering, compacting, and extrapolating the data. This may reduce storage requirements. The result of the consolidation and transformation may be received and/or stored by global cache 130. The global report processor 140 may transform a subset of the data from the plurality of different data sources for reporting, according to the methods further discussed herein. For example, the global report processor may define publishing groups and select a publishing date.

In an alternative embodiment, global report processor 140 may directly receive source data 160 and process the data according to the methods discussed herein, without receiving via a regional cache 110 or consolidation and transformation. In another embodiment, the results of the global report processor 140 may be stored instead of or in addition to providing the data for reports 150.

FIG. 2 illustrates an example delivery schedule 200 of source data and extrapolation and time harmonization methods that may be performed on the basis of the delivery schedule, for example by the consolidation and transformation module 120 shown in FIG. 1. The delivery schedule 200 may be according to timeline labeled with months and weeks (x-axis). In the example shown, the delivery schedule spans January through May, including weeks 1 through 21. Each database is shown as being on a different schedule. The diamonds, circles, and triangles each represents a delivery date. A blank box represents new data available with the latest delivery. A hashed box represents data that available with a previous delivery (“historical data”). For example, each delivery may include historical data such as data for the last three years leading up the present delivery date (not shown). Each unit of information is represented in FIG. 2. For example, in the first delivery for database DE (represented as a diamond labeled “1”), five weeks' worth of data is delivered, including information for each week (e.g., five separate numbers, one for each week). In the first delivery for database US (represented as a circle labeled “1”), four weeks' worth of data is delivered, including information for the entire period (e.g., one number for all four weeks). In the first delivery for database UK, (represented as a triangle labeled “1”), two months' worth of data is delivered, including information for the entire period (e.g., one number for the entire two months). As shown, delivery may be at different times, for example US data beginning before the month of January, while DE and UK begin with the first week.

Database DE may contain weekly data provided 12 times a year following a 5-4-4 pattern, i.e., the first delivery contains five new weeks, the next two deliveries each contains four new weeks, the subsequent delivery contains five new weeks, etc. Data may be reported on a weekly level because data is available at that time granularity. In FIG. 2, the data contained in the first delivery is represented by a bar labeled with “5.” Diamonds represent delivery dates: the first delivery date is labeled as “1,” the second delivery date is labeled as “2,” the third delivery date is labeled as “3,” and the fourth delivery date is labeled as “4.” The first delivery date occurs around the sixth week (which happens to fall in February) and includes five new weeks of data. The second delivery date occurs around the 10^{th} week (which happens to fall in March) and includes four new weeks and five old weeks of data for a total of nine weeks of data. The third delivery date occurs around the 14^{th} week (which happens to fall in April) and includes four new weeks and nine old weeks of data for a total of 13 weeks of data. The fourth delivery occurs around the 19^{th} week (which happens to fall in May) and includes five new weeks of data and 13 weeks of old data for a total of 18 weeks of data. Suppose a report is to be generated for the month of January. Due to the delivery schedule not always being aligned with months, time split may be performed. For example, time split may be performed on the DE data as follows: take all weeks that belong completed to January, take all weeks that overlap with December and February, and split them with corresponding amounts. The rest of the split values belong to December and February. After performing time split, corresponding data for a desired time period, e.g., January, may be reported.

Database US may contain data for four weeks (“4-weekly”) provided 13 times a year. In FIG. 2, the data contained in the first delivery is represented by a bar labeled with “4.” Circles represent delivery dates: the first delivery date is labeled as “1,” the second delivery date is labeled as “2,” the third delivery date is labeled as “3,” the fourth delivery date is labeled as “4,” and the fifth delivery date is labeled as “5.” The first delivery date occurs around the fifth week (which happens to fall in February) and includes four new weeks of data. The second delivery date occurs around the ninth week (which happens to fall in March) and includes four new weeks and four old weeks of data for a total of eight weeks of data. The third delivery date occurs around the 13^{th} week (which happens to fall in April) and includes four new weeks and eight old weeks of data for a total of 12 weeks of data. The fourth delivery occurs around the 17^{th} week (which happens to fall in May) and includes four new weeks of data and 12 weeks of old data for a total of 16 weeks of data. The fifth delivery occurs around the 21^{st} week (which happens to fall in June) and includes four new weeks of data and 16 weeks of old data for a total of 20 weeks of data. Suppose a report is to be generated for the month of January. Due to the delivery schedule not always being aligned with months, time split may be performed. For example, time split may be performed on the US data in a manner similar to that described above with respect to DE. After performing time split, corresponding data for a desired time period, e.g., January, may be reported.

Database UK may contain data for two months (“bi-monthly”) provided six times a year. In FIG. 2, the data contained in the first delivery is represented by a bar labeled with “2 months.” Triangles represent delivery dates: the first delivery date is labeled as “1” and the second delivery date is labeled as “2.” The first delivery date occurs around the ninth week (which happens to fall in March) and includes two months of new data. The second delivery date occurs around the 17^{th} week (which happens to fall in May) and includes two months of old data and two months of new data for a total of four months of data. Suppose a report is to be generated for the month of January. Due to the delivery schedule not always being aligned with months, time split may be performed as follows: UK split the first period into two portions: one for January and one for February. After performing time split, corresponding data for a desired time period, e.g., January, may be reported.

Each of the delivery dates corresponding to the databases DE, US, and UK are shown in the timeline at the bottom of FIG. 2. As shown, the delivery dates do not always coincide with one another, creating the time granularity issues discussed herein. To address these issues, the various granularities may be converted into a common reporting granularity using a “time split function” as discussed in the examples provided herein. That is, the different databases can be unified and/or synthesized to improve reporting.

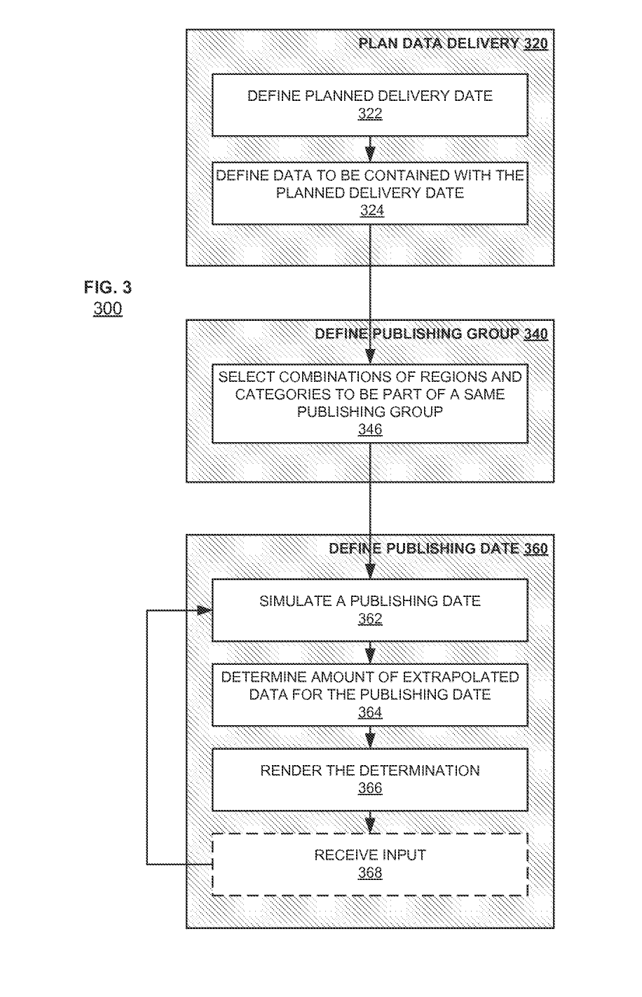

FIG. 3 is a simplified flow chart of a method 300 of selecting a publishing date according to an embodiment. The method 300 may address the issues discussed herein by answering questions such as: what data across deliveries should be grouped and made visible at the same time? When should the data be visible for the end user in a global marketing department? What is the earliest date to publish data with an acceptable amount of extrapolated data? What is an acceptable amount of extrapolated data? The method 300 may include managing publishing groups and defining publishing dates for a publishing group and a calendar month across deliveries of data.

At block 322, the method 300 may determine a planned delivery date. A delivery date may be determined/defined for each database. This may also be referred to as determining a delivery schedule. The delivery date may be the same for each database or different between at least two of the databases. The planned delivery date may be a date agreed upon with a data provider. The planned delivery date may also be defined externally and received by the method 300. The method 300 may then determine what data will be included for a given planned delivery date (box 324). For example, the definition may be up to what date the delivery contains data. In the examples provided in FIG. 2, the second delivery date for database US represented by a circle labeled “2” may be defined to include the immediate prior four aggregated weeks of aggregated data (i.e., a single number representing the four weeks) along with the four prior weeks of “old” data, for a total of eight weeks of data. As another example, for the same delivery date, the data included in a delivery may be defined to include the four weeks of “new” data (without the four prior weeks of “old data”), for a total of four weeks of data. This information may be used later, e.g., for planning a publishing date. In box 326, the method may define a reporting period. The reporting period may be a time span of interest for generating a report. For a given delivery date, data may be contained in the delivery for none of, a portion or, of all of a reporting period. Boxes 322, 324, and 326 may be characterized as a “plan data delivery phase” 320.

At block 346, the method 300 may select categories and regions to be published together. For example, the method may select global categories and countries to be published together. The method may select combinations of categories and regions to be part of a same publishing group. The selections may be made externally and received by method 300. The selections made in box 346 are further described herein with respect to FIG. 4. Box 346 may be characterized as a “define publishing group phase” 360 in which the method 300 groups data that belongs together from a reporting point of view.

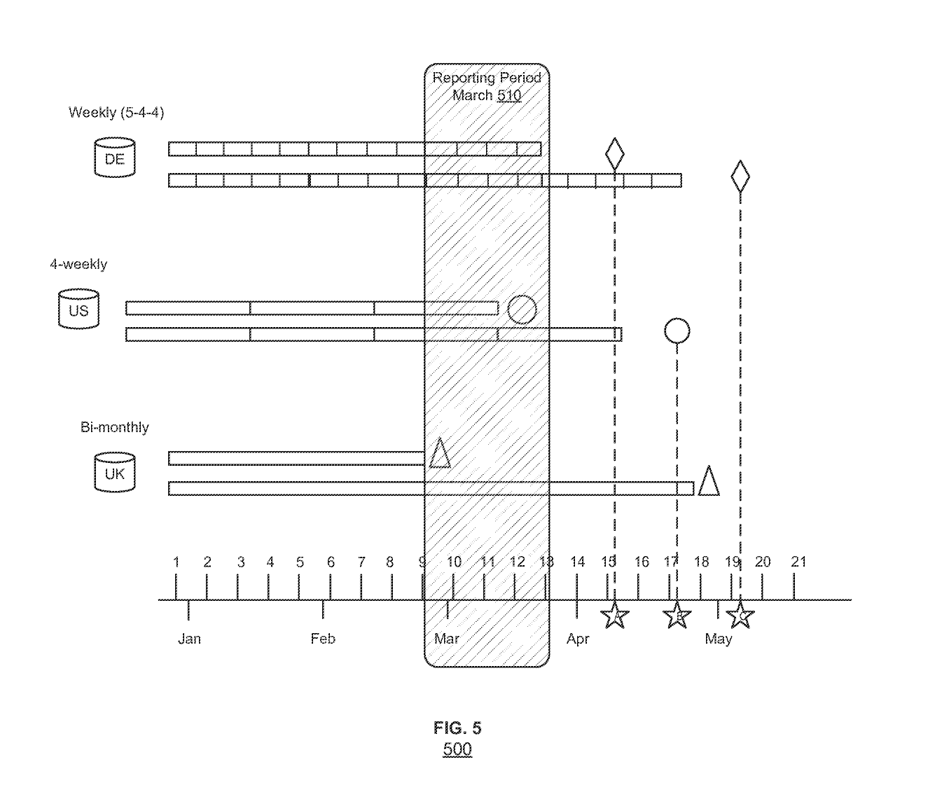

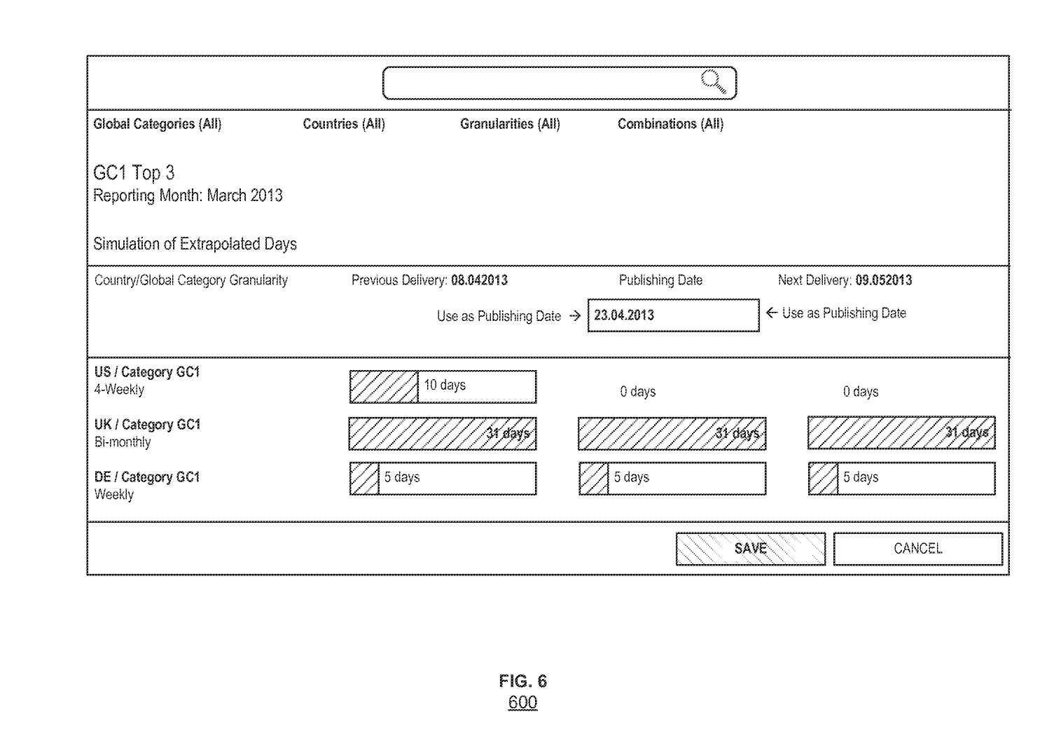

At block 362, the method 300 may simulate a publishing date. The simulation may include gathering data from various databases. Based on the gathered data, the method 300 may determine an amount of data to be extrapolated for a given publishing data (box 364). Data may be considered to be needed to be extrapolated if it is missing or of poor quality. The determination of the amount of data that needs to be extrapolated is further described herein with respect to FIG. 5. In box 366, the method 300 may render the result of the determination, for example in the form of a bar graph. An exemplary GUI including the rendered result is shown in FIG. 6. The result may be displayed to a display device. Boxes 362, 364, 366, 368 may be characterized as a “define publishing date” phase.

Optionally, the method 300 may receive input, for example via a GUI (box 368). The input may cause the method 300 to proceed to box 362 to perform additional simulation(s). The input may be changes to publishing dates and database. For example, a user may input different publishing dates, e.g., moving the publishing date to a later point in time when more data may be available and less data would need to be extrapolated. Alternatively, the publishing date may be moved to an earlier point in time. The method 300 may then repeat boxes 362 to 366, and may determine that additional extrapolated days are tolerable. Thus, it is possible to find a balance between publishing a report at an early time with a tolerable level of extrapolated data. Filtering possibilities draws a focus on more important databases, e.g., databases more relevant to a publishing group. Decisions may be stored to memory. In an embodiment, the process 300 may be performed at a predefinable time period. For example, the process 300 may be performed for each calendar month, e.g., each GUI may be for a calendar month. As another example, the process may be performed weekly.

FIG. 4A illustrates an exemplary scheme 400 for defining publishing groups according to an embodiment. The exemplary scheme 400 is shown as having combinations of countries and categories. In the example shown, global groups are designated by a globe icon and categories are designated by a folder icon. A combination may be assigned to multiple publishing groups and may be part of several databases.

For example, publishing group “North America” includes global groups CA, MX, and US, and categories GC1 and GC2. A GC category may represent a global category. For example, a global category may be chocolate, another global category may be milk, yet another global category may be body care, etc. The corresponding data is gathered from databases 402, 403, 404, and 405, each of which belongs to at least one of the global groups and at least one of the categories GC1 and GC2. Publishing group “GC 1 Top 3” includes global groups FR, UK, US, and category GC1. The corresponding data is gathered from databases 405, 406, and 408, which each includes at least one of the global groups and GC1. Publishing group “Europe” includes global groups DE, FR, NL, PL, and UK, and the category GC1. The corresponding data is gathered from databases 406, 412, 414, 416, and 418, each of which includes at least one of the global groups or GC1.

FIG. 4B illustrates an exemplary GUI 450 for defining publishing groups according to an embodiment. The GUI may be used to define and/or edit publishing group “GC Top 3.” For example, a publishing group may be given a name, e.g., “GC Top 3.” The publishing group may also be provided with a description of the members included in the publishing group, e.g., “Germany, Great Britain, United States.” The members of the publishing group each may have their own respective codes, e.g., DE, F, GB to respectively represent Germany, Great Britain, and United States. Relevant produce categories also may be provided, e.g., “GC1.” The information may be provided externally, e.g., by a user via the GUI. A summary of the publishing groups may be rendered in the GUI, for example in a side bar. The summary may include the number of planned publishing dates. The publishing dates may be selected according to the methods described herein.

FIG. 5 illustrates a delivery schedule 500 including a reporting period. For example, data for publishing group “GC1 Top 3” may be reported every month. Data for publishing group “North America” may be reported every odd month. Data for publishing group “Europe” may be reported every even month. As discussed herein, data for each publishing group may be gathered from several databases, the databases operating at different time granularities. For example, “GC1 Top 3” may include DE, US, and UK with databases operating on the schedule shown in FIG. 2.

For a given reporting period, not all of the data may be available. For a report covering data from the month of March, a potential reporting period 510 may be designated. In this example, database DE contains weekly data provided 12 times a year following a 5-4-4 pattern, i.e., the first delivery contains five new weeks, the next two deliveries each contain four new weeks, the subsequent delivery contains five new weeks, etc. Database US contains data for four weeks (“4-weekly”) provided 13 times a year. Database UK contains data for two months (“bi-monthly”) provided six times a year. The diamonds, circles, and triangles represent publishing dates of each of the databases. For example, a report may be published around week 14 for database DE (represented by a diamond). Another report may be published around week 19 (represented by a diamond).

Three sample planned publishing dates are shown in FIG. 5, represented as stars. A report may be generated even without all of the data by extrapolating the missing data. For example, a report may be generated at point A (around week 15). In this situation, data for each of databases DE and US have been partially received. The portion of data for databases US and UK that have not been delivered may be extrapolated. Thus, a minor part of DE data may need to be extrapolated to report complete data. About half of US data may need to be extrapolated. As another example, a report may be generated at point B (around week 17). In this situation, data for two databases (DE and US) may have been delivered. That is, the delivered data for DE and US covers data for the month of March. The data for database UK has not been delivered, but may be extrapolated. As yet another example, a report may be generated at point C (around week 19). In this situation, data for all three databases may have been received.

In the example provided, to report March data based on fully reported data (i.e., without any extrapolated data), one would need to wait until point C, because at that point in time, data is made available by each database: database DE reports the data around week 14 (represented by a diamond labeled “4”), database US reports the data around week 15 (represented by a circle labeled “3”), and database UK reports that data around week 18 (represented by triangle labeled “2”). However, point C is in the middle of May, which may be too late for an intended audience of the report. In other words, reporting at point A corresponds to extrapolating data for all three databases, and reporting at point B corresponds to extrapolating data for one database, and reporting at point C corresponds to not extrapolating data for any of the databases because data for the desired period has been delivered by all databases.

The method may determine and analyze benefits and shortcomings of each situation. For publishing date A, March data may be delivered by database DE only so that part of database US would be partly extrapolated and UK would be completely extrapolated to generate a report. An advantage is that the report would be generated earliest out of the three choices, A, B, and C. For publishing date B, March data may be delivered by databases DE and US, so that UK would be partly extrapolated to generate a report. For publishing date C, March is covered by all three databases, but it may be relatively late because the information for March would be published in May. The method may assign a score to each option based on the cost-benefit analysis and determine that option B is the most desirable because some of the data is available and the date is reasonably early.

FIG. 6 illustrates an exemplary GUI 600 to display various publishing dates and corresponding attributes according to an embodiment. For example, the exemplary GUI 600 may correspond to a publishing group “GC1 Top 3”. The GUI may show several possible publishing dates. For illustrative purposes, three possible publishing dates and the corresponding data extrapolation amounts are shown in GUI 600. A publishing date of “08.042013,” which represents Apr. 8, 2013, has extrapolated: 10 days of US data, 31 days of UK data, and five days of DE data. Publishing date of “23.042013,” which represents Apr. 23, 2013, has extrapolated: zero days of US data, 31 days of UK data, and five days of DE data. Publishing date of 09.052013 (May 9, 2013) may have zero days of US data, zero days of UK data, and five days of DE data extrapolated.

The user may manipulate and change the publishing date to a later point in time when more data is available and less data need to get extrapolated or navigate to an earlier point in time if more extrapolated days are tolerable. Thus, it is possible for a user to easily and quickly visualize the effects of variables related to a publishing date and find a balance between an amount of extrapolation and timeliness of publication.

The methods and systems discussed herein include many advantages. For example, the methods and systems allow for finding an optimal point in time to make market research data available for reporting, e.g., global reporting. Finding such an optimal point in time is useful for many marketing applications. The methods and systems may also assist a user to make and/or supervise a better decision compared with typical methods. For example, a user may define business-relevant publishing groups and run simulations of different publishing dates to more efficiently understand the impact of selecting various publishing dates. Such calculations would not be capable of being performed in one's mind because of the volume of data and simulations.

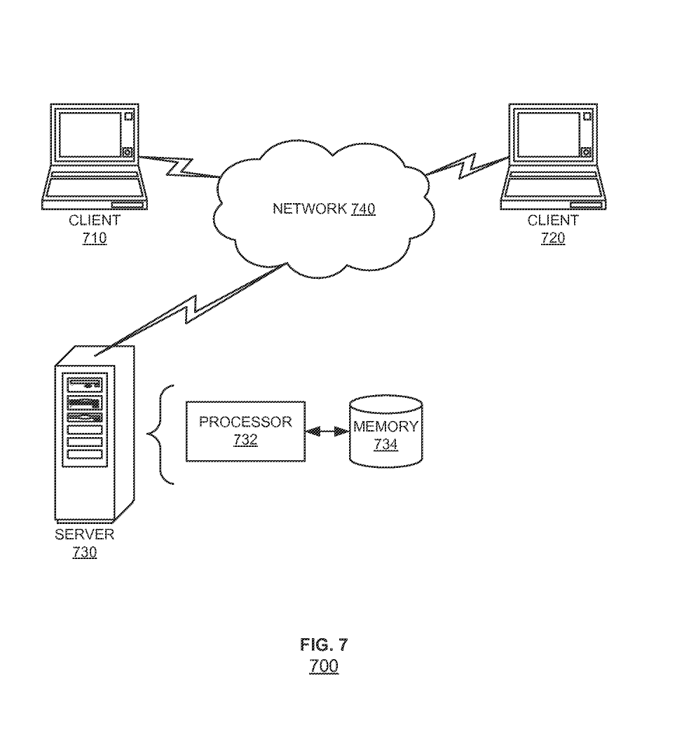

FIG. 7 is a simplified block diagram of a system 700 implementing the methods described herein. The system 700 can include a plurality of clients 710, 720 and a server 730 interconnected via network 740. The server can include a processor 732 in communication with a computer-readable medium 734. The computer-readable medium 734 can be a database internal or external to the processor or external storage means. The computer-readable medium 734 can include instructions executable by the processor such that when the processor executes various portions of the instructions, the instructions cause the processor to perform the various methods described herein. Each of the clients 710, 720 can communicate with the processor 732 to request data stored in the server 730.

In FIG. 7, the clients 710, 720 are illustrated as laptop computers, but the principles of the present invention are not so limited. Embodiments of the present invention find application with personal computers (including desktop computers), tablet computers, and smart mobile device. The network 740 represents any number of networks that convey data between the server 730 and clients 710, 720, including for example wireline and/or wireless communication networks. The network 740 may exchange data in circuit-switched or packet-switched channels. Representative networks include telecommunications networks, local area networks, wide area networks and/or the Internet. For the purposes of the present discussion, the architecture and topology of the network 740 are immaterial to the operation of the present invention unless explained herein.

It should be appreciated that the present invention can be implemented in numerous ways, including as a process, an apparatus, a system, a computer processor executing software instructions, a mobile device, a smart device, a mobile application, or a computer readable medium such as a computer readable storage medium, or a computer network wherein program instructions are sent over optical or electronic communication or non-transitory links. It should be noted that the order of the steps of disclosed processes can be altered within the scope of the invention, as noted in the appended Claims and in the description herein.

The foregoing discussion has described operation of the embodiments of the present invention in the context of terminals that embody downloading systems. Commonly, these components are provided as electronic devices. They can be embodied in integrated circuits, such as application specific integrated circuits, field programmable gate arrays and/or digital signal processors. Alternatively, they can be embodied in computer programs that execute on personal computers, notebook computers, tablet computers, smartphones or computer servers. Such computer programs typically are stored in physical storage media such as electronic-, magnetic- and/or optically-based storage devices, where they are read to a processor under control of an operating system and executed. And, of course, these components may be provided as hybrid systems that distribute functionality across dedicated hardware components and programmed general-purpose processors, as desired.

Several embodiments of the invention are specifically illustrated and/or described herein. However, it will be appreciated that modifications and variations of the invention are covered by the above teachings and within the purview of the appended claims without departing from the spirit and intended scope of the invention.

What is claimed is:

1. A computer-implemented method to select a publishing date, the method comprising:
receiving, by a processor, data from a plurality of data sources;
determining, by the processor, a delivery schedule of each of the plurality of data sources and time-dependent content corresponding to the data contained in each delivery;
defining, by the processor, a publishing group based on the plurality of data sources;
determining, by the processor, an amount of data that is unavailable on the publishing date, wherein the amount of unavailable data is for a reporting period;
determining, by the processor, a length of time between an end of the reporting period and the publishing date; and
selecting, by the processor, the publishing date based on the amount of unavailable data and the length of time between the end of the reporting period and the publishing date.

2. The method of claim 1, wherein the time-dependent content includes a most recent date associated with the data in the respective delivery and data is unavailable for times subsequent to the most recent date.

3. The method of claim 1, wherein the reporting period is user-definable.

4. The method of claim 1, wherein the defining of the publishing group is based on at least one category and at least one geographic region.

5. The method of claim 1, wherein the selection of the publishing date is based on an input received via a graphical user interface.

6. The method of claim 1, wherein an amount of unavailable data for the publishing group is given a greater weight compared with an amount of unavailable data outside the publishing group.

7. The method of claim 1, wherein the publishing date is selected from at least two candidate publishing dates.

8. The method of claim 7, wherein the selected publishing date has at least one of: less unavailable data and less length of time between the end of the reporting period and the publishing date, compared with the other candidate publishing dates.

9. The method of claim 1, wherein the unavailable data includes extrapolated data.

10. The method of claim 1, further comprising:
receiving the publishing date as an input; and
responsive to receiving the publishing date as an input, simulating the at least one publishing date based on the received input.

11. The method of claim 10, further comprising:
rendering the amount of unavailable data for the publishing date on a graphical user interface;
receiving the input via adjustments to the graphical user interface; and
updating the graphical user interface to reflect the simulating of the input publishing date.

12. A system to determine a publishing date, the system comprising:
an interface to receive data from a plurality of data sources, wherein at least one of the data sources provides data on first delivery date, and at least one other data source provides data on a second delivery date, wherein the first delivery date and the second delivery date are different from one another; and
a processor to perform the steps of:
determining time-dependent content corresponding to the data contained in each delivery, wherein the time-dependent content includes a most recent date associated with the data in the respective delivery and data is unavailable for times subsequent to the most recent date;
defining a publishing group based on the plurality of data sources;
determining an amount of data that is unavailable on the publishing date, wherein the amount of unavailable data is for a user-definable reporting period;
determining a length of time between an end of the reporting period and the publishing date; and
selecting the publishing date based on the amount of unavailable data and the length of time between the end of the reporting period and the publishing date.

13. The system of claim 11, wherein:
an amount of unavailable data for the publishing group is given a greater weight compared with an amount of unavailable data outside the publishing group; and
the publishing date is selected from at least two candidate publishing dates.

14. The system of claim 11, wherein the unavailable data includes extrapolated data.

15. The system of claim 11, further comprising:
receiving the publishing date as an input; and
responsive to receiving the publishing date as an input, simulating the at least one publishing date based on the received input.

16. The system of claim 11, further comprising: rendering the amount of unavailable data on a graphical user interface;
receiving the input via adjustments to the graphical user interface; and
updating the graphical user interface to reflect the simulating of the input publishing date.

17. A non-transitory computer readable medium, storing computer program instructions, executable by a processor to control a system to:
receive data from a plurality of data sources;
determine a delivery schedule of each of the plurality of data sources and time-dependent content corresponding to the data contained in each delivery;
define a publishing group based on the plurality of data sources;
determine an amount of data that is unavailable on the publishing date, wherein the amount of unavailable data is for a reporting period;
determine a length of time between an end of the reporting period and the publishing date; and
select the publishing date based on the amount of unavailable data and the length of time between the end of the reporting period and the publishing date.

18. The non-transitory computer readable medium of claim 17, wherein the processor further controls the system to:
receive the publishing date as an input; and
responsive to receiving the publishing date as an input, simulate the at least one publishing date based on the received input.

19. The non-transitory computer readable medium of claim 17, wherein the processor further controls the system to:
render the amount of unavailable data on a graphical user interface;
receive the input via adjustments to the graphical user interface; and
update the graphical user interface to reflect the simulating of the input publishing date.

20. A computer-implemented method to select a publishing date from candidate publishing dates, the method comprising:
receiving, by a processor, data from a plurality of data sources;
determining, by the processor, a delivery schedule of each of the plurality of data sources and an amount of data contained in each delivery, wherein the delivery schedule of at least two of the plurality of data sources are different;
defining, by the processor, a publishing group including a combination of regions and product categories reflecting the plurality of data sources;
determining, by the processor, an amount of data for the publishing group for a reporting period that is extrapolated on each candidate publishing date; and
selecting, by the processor, the publishing date from the candidate publishing dates based on an optimization of the amount of extrapolated data and a length of time between an end of the reporting period and each of the candidate publishing dates.
